(19) United States
(12) Patent Application Publication
(10) Pub. No.: US 2012/0062560 A1
(43) Pub. Date: Mar. 15, 2012

(54) STEREOSCOPIC THREE DIMENSIONAL PROJECTION AND DISPLAY

(75) Inventors: Cornel Swoboda, Bruehl (DE); Michael Stougiannos, East Brunswick, NJ (US); Ingo Nadler, Bonn (DE)

(73) Assignee: STEREONICS, INC., Massapequa, NY (US)

(21) Appl. No.: 13/229,718

(22) Filed: Sep. 10, 2011

Related U.S. Application Data
(60) Provisional application No. 61/381,915, filed on Sep. 10, 2010.

(51) Int. Cl. G06T 15/00

(52) U.S. Cl. 345/419

(57) ABSTRACT

A hardware and software independent method and system of providing three-dimensional stereoscopic presentations of simulations which lack 3D stereoscopic graphics is provided wherein advanced graphics features such as view modulation, user tracking, geometry warping, edge blending and interweaved views, are each provided in stereoscopic 3D, allowing for raster-based and projector-based screen projection including multiple tile presentations. Further provided are hardware and software independent motion inputs for simulator seats based on the motion effects produced in simulator applications lacking motion output for simulator seats via translation of simulator camera data into motion input.

### CROSS REFERENCE TO RELATED APPLICATIONS

This application claims the benefit of and priority to U.S. Provisional Patent Application No. 61/381,915, filed Sep. 10, 2010, the disclosure of which is hereby incorporated by reference in its entirety.

### FIELD OF THE INVENTION

The present invention relates to a system and method of converting two dimensional signals to allow stereoscopic three dimension projection or display.

### BACKGROUND

Although existing software in the simulation and multimedia fields project and display images and video on systems which use sophisticated hardware and software display technology capable of three-dimensional projection or display, much existing software lacks the ability to deliver stereoscopic three dimensional viewing and instead projects and display all or the bulk of the images in two dimensions, with little or limited three dimension capability. For example, flight simulator software suffers from a lack of 3D content which means that pilots are currently trained with a less desirable and less realistic simulation of actual flight conditions, especially with respect to objects moving around them.

Under current technology, conversion of simulator software would necessitate rewriting the software's display code because a precondition for the creation of a three dimensional effect is the provisioning of an application developed for this purpose. Currently a small number of the software products support stereoscopic image representation because of the complicated combination of software and hardware required for the creation of the 3D effect. Thus, individual applications with direct access to the hardware are required, creating a large hurdle to the implementation of stereoscopic 3D across simulator platforms. Further complicating efforts to provide stereoscopic 3D is the fact that many standardized software interfaces did not or currently do not support stereoscopic 3D, thus older applications developed with these interfaces cannot support a stereoscopic mode.

Three dimensional views are created because each eye sees the world from a slightly different vantage point. Distance to objects is then perceived by the depth perception process which combines the signals from each eye. Depth perception must be simulated by computer displays and projection systems.

Stereoscopic representation involves presenting information for different pictures, one for each eye. The result is the presentation of at least two stereoscopic pictures, one for the left eye and one for the right eye. Stereoscopic representation systems often work with additional accessories for the user, such as active or passive 3D eyeglasses. Auto-stereoscopic presentation is also possible, which functions without active or passive 3D eyeglasses.

Passive polarized eyeglasses are commonly used due to their low cost of manufacture. Polarized eyeglasses use orthogonal or circular polarizing filters to extinguish right or left handed light from each eye, thus presenting only one image to each eye. Use of a circular polarizing filter allows the viewer some freedom to tilt their head during viewing without disrupting the 3D effect.

Active eyeglasses such as Shutter eyeglasses are commonly used due to their low cost of manufacture. Shutter eyeglasses consist of a liquid crystal blocker in front of each eye which serves block or pass light through in synchronization with the images on the computer display, using the concept of alternate-frame sequencing.

Stereoscopic pictures, which yield a stereo pair, are provided in a fast sequence alternating between left and right, and then switched to a black picture to block the particular eye's view. In the same rhythm, the picture is changed on the output display device (e.g. screen or monitor). Due to the fast picture changes (often at least 25 times a second) the observer has the impression that the representation is simultaneous and this leads to the creating of a stereoscopic 3D effect.

At least one attempt (Zmuda EP 1249134) been made to develop an application which can convert graphical output signals from software applications into stereoscopic 3D signals, but this application suffers from a number of drawbacks: an inability to cope with a moving viewer, and inability to correct the display by edge blending—resulting in the appearance of lines, and a lack of stereoscopic geometry warping for multiple views. The application also does not provide motion simulation for simulation software which inherently lacks motion output to simulator seats.

What is needed is a method and system capable of converting current simulator software or simulator software output to provide stereoscopic 3D displays which is easy to implement across a variety of application software, does not require rewriting of each existing software platform and presents a high quality user experience which does not suffer from the above drawbacks.

### SUMMARY OF THE INVENTION

According to an exemplary embodiment of the present invention, a method and system which generates stereoscopic 3D output from the graphics output of an existing software application or application programming interface is provided.

According to another exemplary embodiment of the present invention, a method and system is provided which generates stereoscopic 3D output from the graphics output of an existing software application where the output is hardware-independent.

According to yet another exemplary embodiment of the present invention, a method and system which generates stereoscopic 3D output from the graphics output of an existing software application or application programming interface is provided where 2 to N stereoscopic views of each object are generated, where N is an even number (i.e. there is a right and left view).

According to a further exemplary embodiment of the present invention, a method and system of applying edge blending, geometry warping, interleaving and user tracking data to generate advanced stereoscopic 3D views is provided.

According to a still further exemplary embodiment of the present invention, a method and system of applying camera position data to calculate and output motion data to a simulator seat is provided.

### BRIEF DESCRIPTION OF THE DRAWINGS

FIG. 1A is a depiction of a system for converting application software graphics output into stereoscopic 3D.

FIG. 1B is a depiction of a system for converting application software graphics output into stereoscopic 3D.

FIG. 1C is a depiction of a system for converting application software graphics output into stereoscopic 3D.

FIG. 1D is a depiction of a system for converting application software graphics output into stereoscopic 3D.

FIG. 2 is a flowchart depicting a process for converting application software graphics calls into stereoscopic 3D calls.

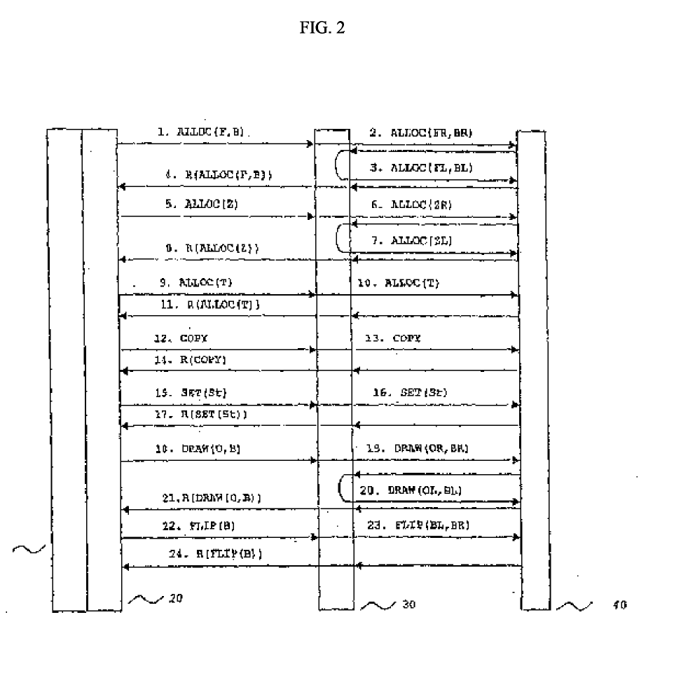

FIG. 3A is a flowchart depicting a process for converting application software graphics output into stereoscopic 3D.

FIG. 3B is a flowchart depicting a process for converting application software graphics output into stereoscopic 3D.

FIG. 3C is a flowchart depicting a process for converting application software graphics output into stereoscopic 3D.

FIG. 3D is a flowchart depicting a process for converting application software graphics output into stereoscopic 3D.

FIG. 3E is a flowchart depicting a process for converting application software graphics output into stereoscopic 3D.

FIG. 4 is a flowchart depicting a process for the conversion of application camera data into simulator seat motion.

### DETAILED DESCRIPTION OF THE INVENTION

In order to provide a hardware independent conversion of monocular and non stereoscopic 3D graphics to stereoscopic 3D signals capable of being displayed on existing projection and display systems, a further application or module (hereafter also “stereo 3D module” or “module”) is provided between the graphics driver and the application or can be incorporated into the application code itself.

The application can be any simulator or other software application (hereafter also “simulator application” or “application”) which displays graphics—for example, a flight simulator, ship simulator, land vehicle simulator, or game. The graphics driver (hereafter also “driver”) can be any graphics driver for use with 3D capable hardware, including standard graphics drivers such as ATI, Intel, Matrox and nVidia drivers. The 3D stereo module is preferably implemented by software means, but may also be implemented by firmware or a combination of firmware and software.

In exemplary embodiments of the present invention which are further described below, the stereo 3D module can reside between the application and the application programming interface (API), between the API and the driver or can itself form part of an API.

In an exemplary embodiment of the present invention, stereoscopic 3D presentation is achieved by providing stereoscopic images in the stereo 3D module and by delivery of the stereoscopic images to a display system by means of an extended switching function. Calls are provided by the simulator application or application programming interface to the stereo 3D module. These calls are examined by the stereo 3D module, and in cases where the module determines that a call is to be carried out separately for each stereoscopic image, a corresponding transformation of the call is performed by the module in order to achieve a separate performing of the call for each of the stereoscopic images in the driver. This occurs either by transformation into a further call, which can for example be an extended parameter list or by transformation into several further calls which are sent several times from the module to the driver.

The stereo 3D module interprets calls received from the application and processes the calls to achieve a stereoscopic presentation. The stereoscopic signals are generated in the stereo module which then instructs the hardware to generate the stereoscopic presentation. This is achieved by an extended switching function which occurs in the stereo 3D module.

The stereo 3D module has means for receiving a call from the application, examining the received call, processing the received call and forwarding the received call or processed calls. The examination means examines the received call to determine whether it is a call which should performed separately for each of the stereoscopic pictures in order to generate stereoscopic views and thus should be further processed. Examples of such a call include calls for monoscopic objects. If the examining means determines that the call should be further processed, the call is processed by processing means which converts the call into calls for each left and right stereoscopic picture and forwards the 3D stereoscopic calls to the driver. If the examining means determines that the call does not need further processing, for example if it is not an image call, or if it is already a 3D stereoscopic call, then the call is forwarded to the driver by forwarding means.

An exemplary embodiment of the present invention is now presented with reference to the creation of a 3D stereoscopic scene in a computer simulation, which is to be understood as a non-limiting example.

In a typical computer simulation a scene is presented on the output device by first creating a three dimensional model by means of a modeling method. This three dimensional model is then represented on a two-dimensional virtual picture space, creating a two dimensional virtual picture via a method referred to as transformation. Lastly, a raster conversion method is used to convert the virtual picture on a raster oriented output device such as a computer monitor.

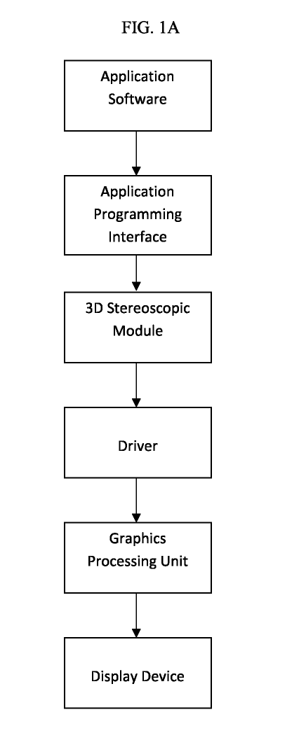

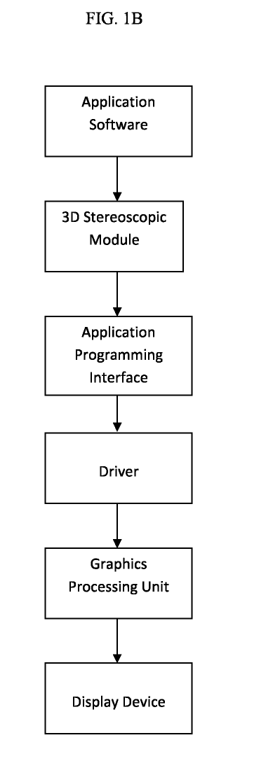

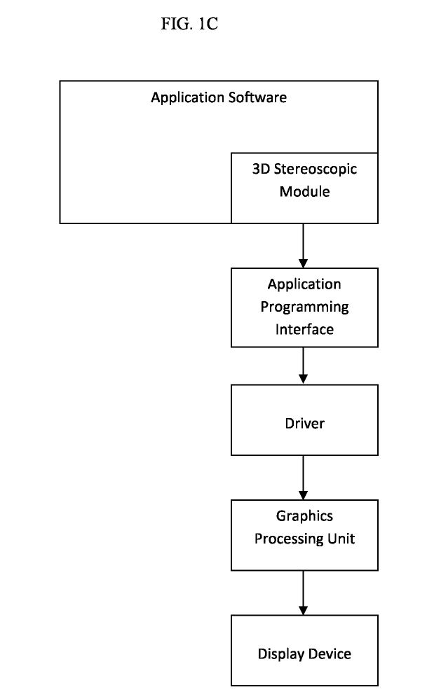

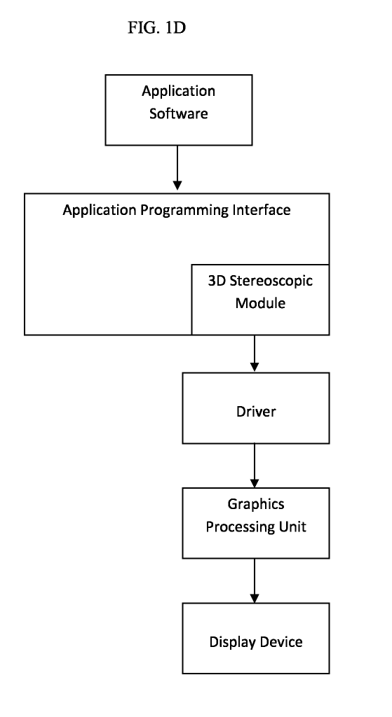

Referring now to FIGS. 1A-D, in an exemplary embodiment of the present invention a stack is provided comprising five units: an application, an application programming interface, a 3D stereo module, a driver and hardware (for example a graphics processing unit and display device).

In a non 3D stereoscopic application, for example a monoscopic application, monoscopic calls are sent from the application programming interface to the driver. In exemplary embodiments of the present invention the 3D stereo module catches the monoscopic driver calls before they reach the driver. The calls are then processed into device independent stereoscopic calls. After processing by the 3D stereo module, the calls are delivered to the driver which converts them into device dependent hardware calls which cause a 3D stereoscopic picture to be presented on the display device, for example a raster or projector display device.

In another exemplary embodiment of the present invention, and referring to FIG. 1B, the 3D stereo module is located between the application and the application programming interface, and thus delivers 3D stereo calls to the application programming interface, which then communicates with the driver which in turn controls the graphics display hardware. In yet another exemplary embodiment the 3D stereo module is incorporated as part of either the application or the application programming interface.

In exemplary embodiments of the present invention, geometric modeling is used to represent 3D objects. Methods of geometrical modeling are widely known in the art and include non-uniform rational basis spline, polygonal mesh modeling, polygonal mesh subdivision, parametric, implicit and free form modeling among others. The result of such modeling is a model or object, for which characteristics such as volume, surface, surface textures, shading and reflection are computed geometrically. The result of geometric modeling is a computed three-dimensional model of a scene which is ten converted by presentation schema means into a virtual picture capable of presentation on a display device.

Models of scenes, as well as virtual pictures are built from basic objects—so-called graphical primitives or primitives. Use of primitives enables fast generation of scenes via hardware support, which generates an output picture from the primitives.

A virtual picture is generated by means for projection of a three-dimensional model onto a two-dimensional virtual picture space, referred to as transformation. In order to project a three-dimensional object onto a two-dimensional plane, projection of the corner points of the object is used. Thus, points defined by means of three-dimensional x, y, z coordinates are converted into two-dimensional points represented by x, y coordinates. Perspective can be achieved by means of central projection by using a camera perspective for the observer which creates a projection plane based on observer position and direction. Projection of three-dimensional objects is then performed onto this projection plane. In addition to projection, models can be scaled, rotated or moved by means of mathematical techniques such as matrices, for example, transformation matrices, where one or more matrices multiply the corner points. In transformation matrices, individual matrices are multiplied with each other to combine into one transformation matrix which is then applied to all corner points of a model. Thus modification of a camera perspective can be achieved by corresponding modification of the matrix. Stereoscopic presentation is achieved by making two or more separate pictures, at least one for each eye of the viewer, by modifying the transformation matrices.

In exemplary embodiments of the present invention, z values can be used to generate the second or Nth picture for purposes of stereoscopic presentation by moving the value of corner points for all objects horizontally for one or the other eye creating a depth impression. For objects behind the surface of the viewing screen the left image is moved to the left and the right image to the right as compared to the original monoscopic image and vice versa for object which are to appear in front of the viewing screen. A nonlinear shift function can also be applied, in which the magnitude of the object shift is based on whether the object is a background or foreground object.

Preferably one of two preferable methods is used to determine the value used to move objects for use in creating stereoscopic images in exemplary embodiments of the present invention—these methods being use of z-value or hardware-based transformation.

In exemplary embodiments of the present invention, the z-value can be used to move objects to create 2 to N left and right stereoscopic views. A z-buffer contains the z-values for all corner points of the primitives in any given scene or picture. The distance to move each object for each view can be determined from these z-values. The corner points having a z-value that means that these points are deeper are moved by a greater value than the corner points which are located closer to the observer. Closer points are either moved by a smaller value, or if they are to appear in the front of the screen, they are moved in the opposite direction (i.e. moved left for the right view and moved right for the left view). Using the z-value method, the 3D stereo module can generate stereoscopic pictures from a virtual picture provided by an application or application programming interface.

In exemplary embodiments of the present invention, hardware transformation can generate a transformed geometric model. The graphics and display hardware receives a geometric model and a transformation matrix for transforming the geometric model. The 3D stereo module can generate stereoscopic pictures by modifying the matrix provided to the hardware, for example by modifying camera perspective, camera position and vision direction of an object to generate 2 to N stereoscopic pictures from one picture. The hardware is then able to generate stereoscopic views for each object.

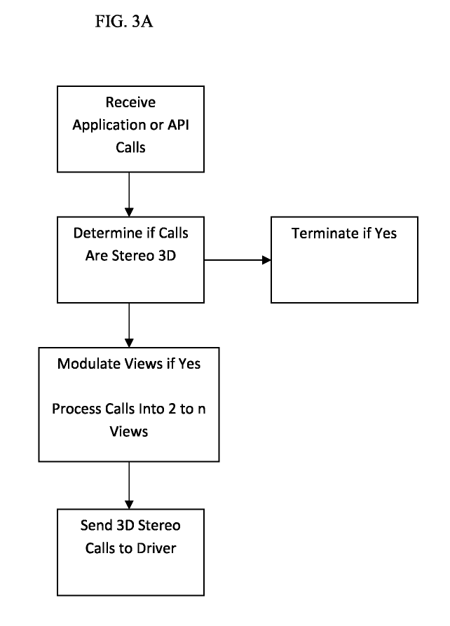

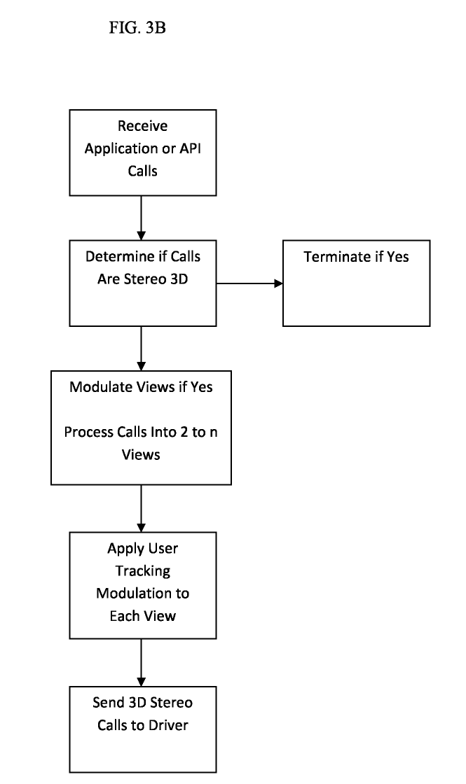

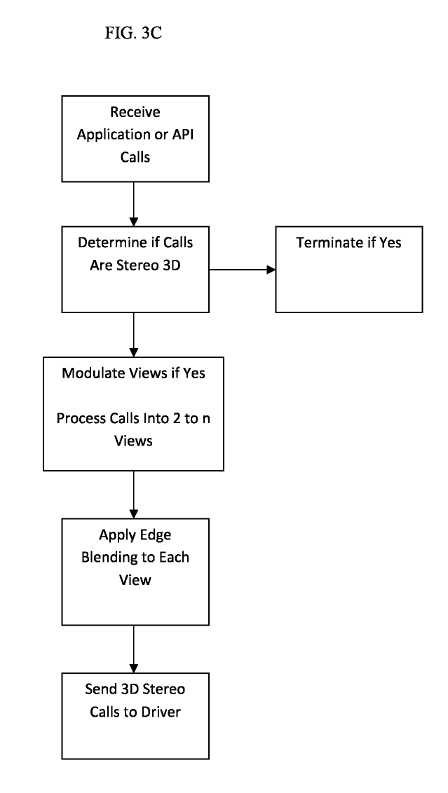

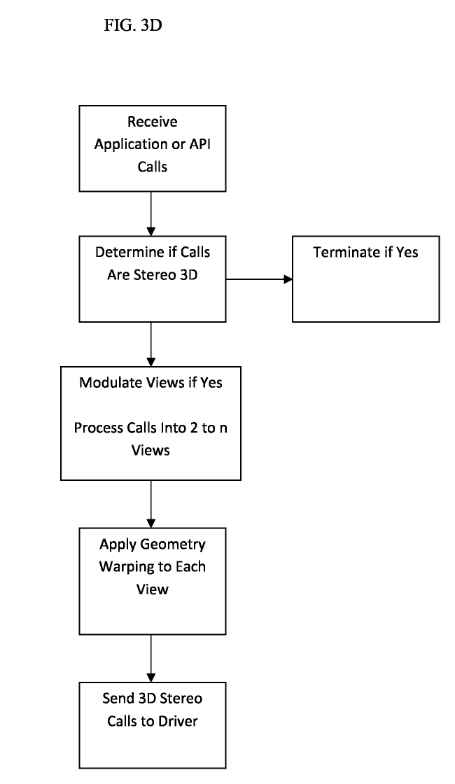

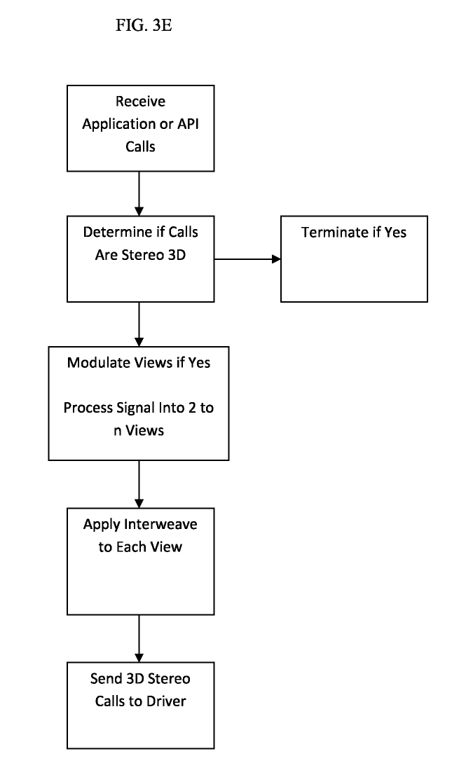

Referring now to FIG. 3, an exemplary embodiment of the call handling of the present invention is presented. The 3D stereo module 30 is located between a programming interface 20 and a driver 40. The application 10 communicates with the programming interface 20 by providing it with calls for graphics presentations, the call flow being represented by arrows between steps 1-24.

As described previously, the 3D stereo module first determines if a call is stereoscopic or monoscopic. This can be done for example by examining the memory allocation for the generation of pictures. Monoscopic calls will allocate either two or three image buffers whereas stereoscopic calls will allocate more than three image buffers.

In the event a stereoscopic call is detected, the following steps are performed. First, the 3D stereo module receives the driver call ALLOC (F,B) from the application programming interface which is a call to allocate buffer memory for storage and generation of images. In step 2, the stereo 3D module then duplicates or multiplies the ALLOC (F,B) call so that instructions for two to N images to be stored and generated are created (ALLOC (FR, BR)) for example for a right image and (ALLOC (FL, BL)) are created—further where more than two views are to be presented (ALLOC (FR₁, BR₁)), (ALLOC (FL₁, BL₁)); (ALLOC (FR₂, BR₂)), (ALLOC (FL₂, BL₂)); (ALLOC (FRₙ, BRₙ), (ALLOC (FLₙ, BLₙ)) and so on can be created. In step 3 the memory address for each ALLOC call is stored. In step 4 the memory addresses for one eye (e.g. the right image) are given to the application as a return value, while the second set of addresses for the other eye are stored in the 3D stereo module. In step 5, the 3D stereo module receives a driver call (ALLOC(Z)) for the allocation of z-buffer memory space from the application programming interface which is handled in the same way as the allocations for the image buffer (ALLOC (FR, BR)) and (ALLOC (FL, BL))—that is (ALLOC (ZL)) and (ALLOC (ZR)) are created in steps 6 and 7 respectively. The application programming interface or application receives a return value for one eye—e.g. (ALLOC (ZR))—and the other eye is administered by the 3D stereo module.

Allocation of memory space for textures is performed in steps 9 and 10. In step 9 the driver call (ALLOC(T)) is sent to the 3D stereo module and forwarded to the driver in step 10. Allocation of memory space can refer to several textures. In step 11 the address of the texture allocation space is forwarded by the application programming interface to the application by (R(ALLOC(T))). Similarly in step 13 the call to copy textures is forwarded to the driver by the stereo 3D module and the result returned to the application in step 14 (COPY) and R(COPY). The texture and copy calls need not be duplicated for a particular pair of views because the calls apply equally to both the right and left images. Similarly, driver call (SET(St)) which sets the drawing operations (e.g. the application of textures to subsequent drawings) in steps 15, 16 and 17 is carried out only once since it applies equally to both left and right views.

Driver call (DRAW) initiates the drawing of an image. The 3D stereo module provisions two or more separate images (one pair for two eyes) from a virtual picture delivered by the application or application programming interface in step 18. Receipt of the driver call (DRAW(0)) by the 3D stereo module from the application programming interface or application causes the module to draw two to N separate images based on z-value methods or transformation matrix methods described previously. Every driver call to draw an object is modified by the 3D stereo module to result in two to N draw functions at steps 19 and 20, one for each eye of each view—e.g. (DRAW (OL, BL)) and (DRAW (OR, BR)) or in the case or N views, (DRAW (OL₁, BL₁)), (DRAW (OR₁, BR₁)); (DRAW (OL₂, BL₂)), (DRAW (OR₂, BR₂)); (DRAW (OLₙ, BLₙ)), (DRAW (ORₙ, BRₙ) and so on. The result is delivered to the application as R(DRAW(O,B)) in step 21.

In yet another exemplary embodiment of the present invention, a nonlinear shift function can also be applied, either alone or in combination with a linear shift function. For example, in a nonlinear shift function the magnitude of the object shift can be based on whether the object is a background or foreground object. The distribution of objects within a given scene or setting can sometimes require a distortion of depth space for cinematic or dramaturgic purposes and thus to distribute the objects more evenly or simply in a different way in perceived stereoscopic depth.

In yet another exemplary embodiment of the present invention, applying vertex shading avoids the need to intercept each individual call because it functions at the draw stage. Vertex shaders built onto modern graphics cards can be utilized to create a non-linear depth distribution in real time. In order to use the function of a vertex shader, real time stereoscopic view generation by the 3D stereo module is utilizied. Modulation of geometry occurs by applying a vertex shader the reads a linear, geometric or non linear transformation table or array and applies it to the vertices of the scene for each buffer. Before outputting the final stereoscopic 2 or more images, an additional render process is applied. This render process uses either an algorithm or a depth map to modulate the z position of each vertex in the scene and then render the desired stereoscopic perspectives. By modulating the depth map or algorithm in real time, advanced stereoscopic effects, such as 3D vertigo can be achieved easily from within real time applications or games. More particularly, post processing of a scene can be used to rotate and render the scene twice, which creates a stereoscopic effect. This differs from linear methods where the camera is moved and a second virtual picture is taken.

After generation of two complete images, the replacement of displayed images presented on the output device by the new images from the background buffer is accomplished by means of a switching function—driver call (FLIP (B)) or extended driver call FLIP at step 22. The stereo 3D module will issue driver calls for each left and right view—i.e. (FLIP (BL, BR)) at step 23, thus instructing the driver to display the correct stereoscopic images instead of a monoscopic image. The aforementioned drawing steps DRAW and SET are repeated until a scene is completed (e.g. a frame of a moving picture) in stereoscopic 3D.

In yet another exemplary embodiment, the above driver calls can be sent from the 3D stereo module as single calls by means of parameter lists. For example a driver call (ALLOC (F, B)) can be parameterized as follows: ALLOC (FR, BR,FL,BL) or ALLOC (FR₂₋ₙ, BR_{2-n,FL2-n},BL₂₋ₙ) where the parameters are interpreted by the driver as a list of operations.

Since the 3D stereo module is software and hardware independent the above function are by way of example and other application programming interface calls (API) to drivers may be substituted.

In another exemplary embodiment of the present invention, and referring now to FIG. 3A, the stereo 3D module provides 2 or more views, that is 2 to N views, so as to take viewer(s) field of vision, screen position and virtual aperture of the application into account. View modulation allows stereo 3D to be available for multiple viewer audiences by presenting two views to viewers no matter their location in relation to the screen. By using matrix multiplication, view modulation is thus possible. Matrices contain the angles of new views and the angles between each view and variables for field of vision, screen position and virtual aperture of the application. View modulation can also be accomplished by rotating the scene, that is changing the turning point instead of the matrix. View modulation can be utilized with user tracking features, edge blending and stereoscopic geometry warping. That is, user tracking features, edge blending and stereoscopic geometry warping are applied to each view generated by view modulation.

In another exemplary embodiment of the present invention, and referring now to FIG. 3B, user tracking allows the presentation of stereoscopic 3D views to a moving viewer. The output from view modulation is further modulated using another matrix which contains variables for the position of the user. User position data can be provided by optical tracking, magnetic tracking, WIFI tracking, wireless broadcast, GPS or any other method which provides position of the viewer relative to the screen. User tracking allows for the rapid redrawing of frames as a user moves, with the redrawing occurring within one frame.

In yet another exemplary embodiment of the present invention, and referring now to FIG. 3C, where multiple tiles are presented, for example on a larger screen, edge blending reduces the appearance of borders (e.g. lines) between each tile. The module accomplishes edge blending by applying a transparency map, fading to black both the right and left images in opposite directions and then superimposing the images to create one image. In order to achieve this, for example for two views, a total of 4 images are generated and stored (LR1 and LR2), which are overlapping. The transparency map can be created in two ways. One is manually instructing the application to fade each projector to black during the setup of the module. In another, and more preferable way, a feedback loop is used that generates test images and performs calculations—for example, by creating a transparency or a pixel accurate displacement map to generate an edge blending map by projecting and recording with a camera to create a transparency map. Thus, each channel, i.e. projector, is mapped.

In still another exemplary embodiment of the present invention, and referring now to FIG. 3D, Stereoscopic geometry warping of each view is achieved by the module by first projecting a test grid, storing a picture of that grid and then mapping each image onto the test grid or mesh for each view. The result is that flat images are re-rendered onto the resulting grid geometry, allowing pre-distortion of images before projection onto the screen. In another embodiment, dynamic geometry warping may be carried out on a per frame basis by the module.

In a further exemplary embodiment of the present invention, and referring now to FIG. 3E, stereoscopic interweave views allows the module to mix views for display devices, for example, for eyeglass free 3D televisions and projectors. The module can dynamically interweave, using user tracking data to generate mixdown patterns as the user moves. The module's interweaving process uses a sub pixel based view map which may also be dynamic, based on user tracking, which determines which sub pixel from which view has to be used as the corresponding sub pixel in the final display buffer.

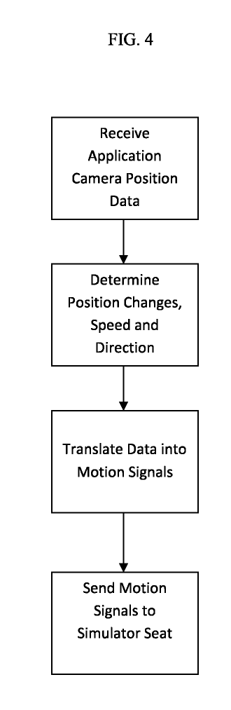

In yet another exemplary embodiment, and referring now to FIG. 4, motion simulation can also be achieved from applications which lack this function by translating G-forces and other movements and providing the data to a moveable simulator seat for example. Application camera data from gaming or simulator applications can be extracted by the stereo 3D module to determine how the application camera moved during a simulation, thus allowing for the calculation of G-force and motion data which can be presented to a physical real motion simulator seat, resulting in motion being applied by that seat which correlates to the motion of the application camera. In this way, realistic crashes, g-forces and movements of the piloted craft are presented to and experienced by the operator of application and simulator software which lack this capability. Preferably, safety overrides are built into either the software or hardware or both, such that injurious movements are prevented.

The following non-limiting examples serve to illustrate applications of exemplary embodiments of the present invention.

### EXAMPLE 1

A non-stereoscopic flight simulator application was rendered into a 3D stereoscopic simulation with moving objects, where views were presented to the observer as the observer moved about the simulator room. A 360 degree flight simulator dome system comprising a simulator globe or dome on which simulated scenes are projected and a cockpit located in or about the center was used in this example. The simulator application and application programming interface was connected to the 3D stereo module, and output from the simulator application was converted into a 3D stereoscopic presentation for use by the drivers and hardware. Edge blended, geometry warped stereoscopic 3D presentations were achieved.

### EXAMPLE 2

The monoscopic video game, POLE POSITION, was rendered into a fully functional stereoscopic 3D game with the motion output to a moveable flight simulator seat, which reacted with real life motion as the simulated vehicle moved and crashed, including motions for G-forces, turns and rapid deceleration as a result of the simulated vehicle hitting a simulated wall. The POLE POSITION application was connected and application programming interface was connected to the 3D stereo module, and output from the simulator application (monoscopic calls and camera position data) was converted into a 3D stereoscopic presentation and motion data for use by the drivers and hardware.

1. A method of generating stereoscopic images comprising the steps of:
(a) receiving a call from an application programming interface
(b) transforming the call into calls for 2 or more stereoscopic views
(c) forwarding the calls for 2 or more stereoscopic views to a driver
(d) rendering the calls for 2 or more stereoscopic views into 2 or more stereoscopic views
(e) displaying the stereoscopic views on display hardware.

2. The method of claim 1 wherein the call is transformed into calls for two or more edge blended stereoscopic views.

3. The method of claim 1 wherein the call is transformed into calls for two or more geometry warped stereoscopic views.

4. The method of claim 1 wherein the call is transformed into calls for two or more interleaved stereoscopic views.

5. The method of claim 1 wherein the call is transformed into calls for two or more stereoscopic views based on viewer location.

6. A method of generating stereoscopic images comprising the steps of:
(a) receiving a call from an application
(b) transforming the call into calls for 2 or more stereoscopic views
(c) forwarding the calls for 2 or more stereoscopic views to an application programming interface
(d) forwarding the calls for 2 or more stereoscopic views to a driver
(d) rendering the calls for 2 or more stereoscopic views into 2 or more stereoscopic views
(e) displaying the stereoscopic views on display hardware.

7. The method of claim 6 wherein the call is transformed into calls for two or more edge blended stereoscopic views.

8. The method of claim 6 wherein the call is transformed into calls for two or more geometry warped stereoscopic views.

9. The method of claim 6 wherein the call is transformed into calls for two or more interleaved stereoscopic views.

10. The method of claim 6 wherein the call is transformed into calls for two or more stereoscopic views based on viewer location.

11. A method of generating stereoscopic images comprising the steps of:
(a) sending calls for 2 or more stereoscopic views to an application programming interface
(b) forwarding the calls for 2 or more stereoscopic views to a driver
(c) rendering the calls for 2 or more stereoscopic views into 2 or more stereoscopic views
(d) displaying the stereoscopic views on display hardware wherein an application transforms a monoscopic view call into calls for 2 or more stereoscopic views prior to sending calls for 2 or more stereoscopic views to the application programming interface.

12. The method of claim 11 wherein the call is transformed into calls for two or more edge blended stereoscopic views.

13. The method of claim 11 wherein the call is transformed into calls for two or more geometry warped stereoscopic views.

14. The method of claim 11 wherein the call is transformed into calls for two or more interleaved stereoscopic views.

15. The method of claim 11 wherein the call is transformed into calls for two or more stereoscopic views based on viewer location.

16. A method of generating stereoscopic images comprising the steps of:
(a) sending calls for 2 or more stereoscopic views to a driver
(b) rendering the calls for 2 or more stereoscopic views into 2 or more stereoscopic views
(c) displaying the stereoscopic views on display hardware wherein an application programming interface transforms calls from an application into calls for 2 or more stereoscopic views.

17. The method of claim 16 wherein the call is transformed into calls for two or more edge blended stereoscopic views.

18. The method of claim 16 wherein the call is transformed into calls for two or more geometry warped stereoscopic views.

19. The method of claim 16 wherein the call is transformed into calls for two or more interleaved stereoscopic views.

20. The method of claim 16 wherein the call is transformed into calls for two or more stereoscopic views based on viewer location.

21. A system for generating stereoscopic images comprising:
(a) an application which generates monoscopic calls
(b) an application programming interface
(c) a stereoscopic module
(d) a graphics driver
(e) a graphics processing unit
(f) a display device wherein the stereoscopic module transforms monoscopic calls into calls for 2 or more stereoscopic views.

22. A method of generating motion in a simulator seat comprising:
(a) receiving camera position data from an application or application programming interface
(b) transforming camera position data into vector data
(c) transmitting vector data to a motion-enabled simulator seat.

23. The method of claim 1 wherein stereoscopic views are generated by linear shifts, nonlinear shifts or a combination of linear and nonlinear shifts.

24. The method of claim 6 wherein stereoscopic views are generated by linear shifts, nonlinear shifts or a combination of linear and nonlinear shifts.

25. The method of claim 11 wherein stereoscopic views are generated by linear shifts, nonlinear shifts or a combination of linear and nonlinear shifts.

26. The method of claim 16 wherein stereoscopic views are generated by linear shifts, nonlinear shifts or a combination of linear and nonlinear shifts.
